(19) United States
(12) Patent Application Publication
(10) Pub. No.: US 2019/0386596 A1
(43) Pub. Date: Dec. 19, 2019

(54) SHEET CONVEYING APPARATUS, DOCUMENT READING APPARATUS AND IMAGE FORMING APPARATUS

(71) Applicant: CANON KABUSHIKI KAISHA, Tokyo (JP)

(72) Inventor: Yohei Ohashi, Nagareyama-shi (JP)

(21) Appl. No.: 16/431,859

(22) Filed: Jun. 5, 2019

(30) Foreign Application Priority Data
Jun. 14, 2018 (JP) 2018-113360

(51) Int. Cl. H02P 21/04; B65H 7/20; H02P 8/14; H02P 8/22; G03G 15/08

(52) U.S. Cl. CPC H02P 21/04; B65H 7/20; G03G 15/0808; H02P 8/22; H02P 8/14

(57) ABSTRACT

When field strengthening is constantly performed during driving by a drive motor to inhibit a rotating speed of the drive motor from suddenly fluctuating, power consumption is increased. The field strengthening is performed only during a period during which the field strengthening is required to be performed. Thus, it is possible to reduce a period during which a current value is set to a d-axis current command value (the field strengthening is performed) while the motor is driven. This can prevent increased power consumption.

### BACKGROUND OF THE INVENTION

### Field of the Invention

The present disclosure relates to motor drive control to be performed in a sheet conveying apparatus, an original reading apparatus, and an image forming apparatus.

### Description of the Related Art

As a method of controlling a motor, there has been known a motor control method referred to as “vector control” (or field oriented control (FOC)) as disclosed in U.S. Pat. No. 6,850,027 (B2). This method is specifically implemented through phase feedback control for controlling current values in a rotating coordinate system so as to reduce a deviation between a command phase of a rotor and an actual rotation phase.

In the vector control, there is used a rotating coordinate system in which a d-axis is defined as a magnetic flux direction of the rotor and a q-axis is defined as a direction orthogonal thereto.

In the rotating coordinate system, a q-axis component (q-axis current) of a drive current flowing through each of wiring lines is a torque current component, which generates a torque, while a d-axis component (d-axis current) of the drive current is an excitation current component, which affects the strength of a magnetic flux passing through the winding wire.

In the vector control, the amplitude and phase of the drive current are controlled so as to maintain a rotor load angle of 90° for the purpose of allowing maximum-efficiency operation. In general vector control, the d-axis current is set to “0” to allow the q-axis current to control the torque. As a result, in accordance with an amount of load on the rotor, a minimum required drive current is generated to allow power-efficient drive control to be implemented. In addition, it is possible to suppress vibration and noise of a motor resulting from an excess torque.

In Japanese Patent Application Laid-open No. 2003-88168, there is disclosed a configuration (field strengthening) in which the excitation current component is controlled to have a positive value, to thereby enhance a holding force of a motor. The field strengthening inhibits sudden fluctuations in rotating speed of the motor resulting from fluctuations in the load on the motor. As described in Japanese Patent Application Laid-open No. 2003-88168, when the field strengthening is performed, the excitation current component is controlled to have a positive value.

In other words, when the field strengthening is performed, power consumption is increased as compared with that in a case where the field strengthening is not performed. For example, when the field strengthening is constantly performed during driving of the motor to inhibit the rotating speed of the motor from suddenly fluctuating, the power consumption is increased. It is a primary object of the present disclosure to perform efficient motor control.

### SUMMARY OF THE INVENTION

A sheet conveying apparatus according to the present disclosure includes: a conveying roller configured to convey a sheet; a motor configured to drive the conveying roller; a phase determiner configured to determine a rotation phase of a rotor of the motor; a detector configured to detect a drive current flowing through a winding of the motor; and a controller configured to control the drive current flowing through the winding of the motor such that a deviation between a value of a torque current component of the drive current detected by the detector and a target value of the torque current component is reduced, and to control the drive current flowing through the winding such that a deviation between a value of an excitation current component of the drive current detected by the detector and a target value of the excitation current component, wherein the torque current component is a current component that generates a torque in the rotor and is represented in a rotating coordinate system based on the rotation phase determined by the phase determiner and wherein the excitation current component is a current component that affects a strength of a magnetic flux passing through the winding and is represented in the rotating coordinate system; wherein the controller is configured to set the target value of the torque current component so as to reduce a deviation between an instructed phase indicative of a target phase of the rotor and the rotation phase determined by the phase determiner, wherein the controller is configured to set the target value of the excitation current component such that, during a first period, the magnetic flux passing through the winding wire is stronger than a magnetic flux of the rotor, the first period is a period after a leading end of the sheet reaches a predetermined position upstream of the conveying roller in a direction of conveyance of the sheet, and wherein the controller is configured to set the target value of the excitation current component such that, during a second period, the magnetic flux passing through the winding wire is weaker than the magnetic flux passing through the winding wire during the first period, the second period is a period before the leading end of the sheet reaches the predetermined position.

Further features of this invention will become apparent from the following description of exemplary embodiments (with reference to the attached drawings).

### BRIEF DESCRIPTION OF THE DRAWINGS

FIG. 1 is a cross-sectional configuration diagram of an image forming system in at least one embodiment of the present disclosure.

FIG. 2 is an explanatory diagram of a controller.

FIG. 3 is an exemplary configuration diagram of a motor control device.

FIG. 4 is an explanatory diagram of a motor.

FIG. 5 is a flow chart for illustrating a drive control process.

FIG. 6 is a flow chart for illustrating another drive control process.

### DESCRIPTION OF THE EMBODIMENTS

In the following, a description is given of at least one preferred embodiment of the present disclosure with reference to the drawings. However, in this embodiment, shapes of structural components, positional relationships therebetween, and the like are to be changed as appropriate in accordance with a configuration of an apparatus to which the present disclosure is applied and various conditions, and are not intended to limit the scope of the present disclosure to the following embodiment. Note that, the following description is given of the case in which a motor control device is provided in an image forming apparatus, but an apparatus in which the motor control device is to be provided is not limited to the image forming apparatus. For example, the motor control device is used also in a sheet conveying apparatus configured to convey a sheet such as a recording medium and an original, or in another apparatus.

### Image Forming System

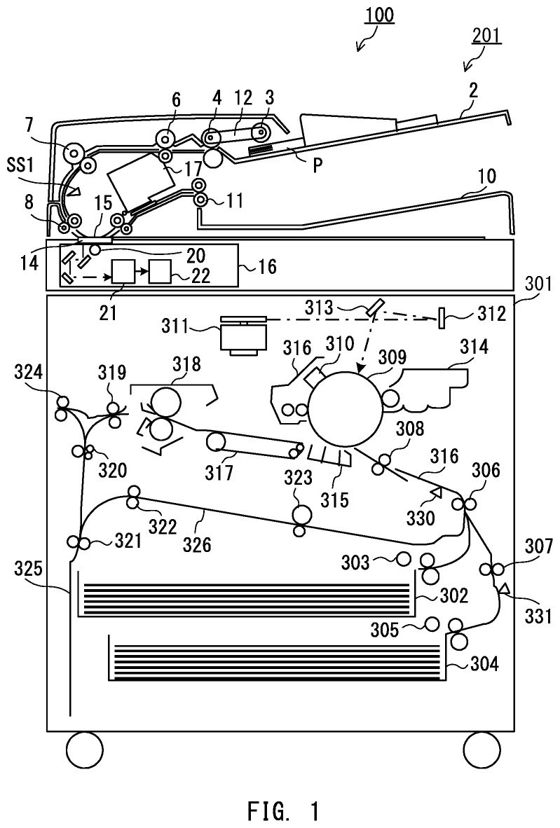

FIG. 1 is a configuration diagram of an image forming system including a motor control device in this embodiment. An image forming system 100 includes an original reading apparatus 201 and an image forming apparatus 301. The image forming system 100 is implemented by, for example, a copying machine, a facsimile apparatus, a printing machine, or a printer. The image forming apparatus 301 forms an image on a recording material in accordance with a predetermined method such as an electrophotographic method and an ink jet method. The image forming apparatus 301 may be configured to form any one of a monochrome image and a color image.

Each of originals P stacked on an original tray 2 of the original reading apparatus 201 is fed by a feed roller 3 and then conveyed by a conveying roller 4. The feed roller 3 and the conveying roller 4 are coupled to each other by a swing arm 12. The swing arm 12 is supported by a rotation shaft of the conveying roller 4 so as to be rotatable around the rotation shaft of the conveying roller 4. The original P is conveyed at a fixed speed by the conveying roller 4 or the like to be delivered by delivery rollers 11 onto a delivery tray 10. A sheet sensor SS1 is provided between conveying rollers 7 and conveying rollers 8 to detect the original P being conveyed. As the sheet sensor SS1, an optical sensor or a sensor flag can be used, for example.

In the original reading apparatus 201, an original reader 16 configured to read an image from a first surface of the original being conveyed is provided. Reflected light from an original image illuminated with light from a lighting device 20 via a reading glass 14 is guided by an optical system made of a reflection mirror to an image reader 21 and converted by the image reader 21 to an image signal.

The image reader 21 includes a lens, a photoelectric conversion element, for example, a charge coupled device (CCD), and a driver for a light source conversion element. The image reader 21 uses the lens to focus the reflected light onto a light receiving surface of the photoelectric conversion element. The photoelectric conversion element performs photoelectric conversion of the received reflected light to generate an analog image signal. The image signal is input to an image processor 22. The image processor 22 performs analog image processing and AD conversion on the obtained image signal to generate digital image data. The image processor 22 transmits the generated image data to the image forming apparatus 301. The image data is data representing the original image.

In the original reading apparatus 201, an original reader 17 configured to read an image from a second surface of the original being conveyed is also provided. The original reader 17 has the same configuration as that of the original reader 16. Image information read by the original reader 17 is output to the image forming apparatus 301 in the same manner as in the method described with respect to the original reader 16.

The portion of the original reading apparatus 201 other than the original readers 16 and 17 corresponds to an original feeding apparatus.

To feed and convey the recording material, the image forming apparatus 301 includes sheet storage trays 302 and 304, feed rollers 303 and 305, conveying rollers 306 and 307, registration rollers 308, and a conveying path 316. Each of the sheet storage trays 302 and 304 stores sheets of the recording material. The respective sheets to be stored in the sheet storage trays 302 and 304 may be of the same type or different types. For example, in the sheet storage tray 302, A4-sized regular paper sheets are stored while, in the sheet storage tray 304, A4-sized thick paper sheets are stored. The recording material is a member on which an image can be formed by the image forming apparatus 301. Examples of the recording material include a paper sheet, a resin sheet, a piece of cloth, an OHP sheet, and a label.

The recording material sheets stored in the sheet storage tray 302 are fed individually on a sheet-by-sheet basis by the feed roller 303 and conveyed by the conveying rollers 306 to the registration rollers 308. The recording material sheets stored in the sheet storage tray 304 are fed individually on a sheet-by-sheet basis by the feed roller 305 and conveyed by the conveying rollers 307 and 306 to the registration rollers 308. The registration rollers 308 are stopped at the time when the recording material sheet is conveyed thereto and performs, for example, skew correction of the conveyed recording material sheet. On an upstream side of the registration rollers 308 in the direction of conveyance of the recording material sheet, there is provided a sheet sensor 330 configured to detect the presence or absence of a recording material sheet being conveyed. On an upstream side of the conveying rollers 307 in the direction of conveyance of the recording material sheet, there is provided a sheet sensor 331 configured to detect the presence or absence of a recording material sheet. An optical sensor or a sensor flag can be used, for example, as each of the sheet sensors 330 and 331.

The image forming apparatus 301 forms an image corresponding to the image data obtained from the original reading apparatus 201. To form a toner image corresponding to the image data, the image forming apparatus 301 includes an optical scanner 311, mirrors 312 and 313, a photosensitive drum 309, a charging device 310, and a developing device 314. To transfer and fix the toner image onto the recording material sheet, the image forming apparatus 301 includes a transfer charging device 315, a conveying belt 317, and a fixing device 318. For sheet delivery and front-back-side inversion after image fixation, the image forming apparatus 301 includes delivery rollers 319, delivery rollers 324, conveying rollers 320, 322, and 323, reverse rollers 321, a reverse path 325, and a double-side path 326.

The optical scanner 311 has a semiconductor laser and a polygon mirror and emits a laser beam corresponding to the image data obtained from the image processor 112. The laser beam emitted from the semiconductor laser is reflected by the mirrors 312 and 313 to illuminate an outer peripheral surface of the photosensitive drum 309.

The photosensitive drum 309 is a drum-shaped photosensitive member configured to rotate at a predetermined speed around a drum shaft. After the outer peripheral surface of the photosensitive drum 309 is uniformly charged by the charging device 310, the optical scanner 311 illuminates the outer peripheral surface of the photosensitive drum 309 with the laser beam to form an electrostatic latent image corresponding to the image data on the outer peripheral surface of the photosensitive drum 309. The charging device 310 charges the outer peripheral surface of the photosensitive drum 309 through use of a corona charging device or a charging roller. The electrostatic latent image is developed by toner contained in the developing device 314 to form a toner image on the outer peripheral surface of the photosensitive drum 309. The toner image formed on the photosensitive drum 309 is transferred onto the recording material sheet by the transfer charging device 315 provided at a position (transfer position) facing the photosensitive drum 309. In this case, the registration rollers 308 convey the recording material sheet to the transfer position at the time when the toner image is formed on the recording material sheet.

The recording material sheet having the toner image transferred thereon is conveyed by the conveying belt 317 to the fixing device 318. The fixing device 318 heats and presses the recording material sheet having the toner image transferred thereon to fix the toner image onto the recording material sheet. Thus, the process of forming the image on the recording material is ended.

When image formation is performed in a single-sided printing mode, the recording material is delivered by the delivery rollers 319 and the delivery rollers 324 from the fixing device 318 to an outside of the image forming apparatus 301.

When image formation is performed in a double-sided printing mode, the recording material having an image formed on a first surface thereof is conveyed by the conveying rollers 320 and the reverse rollers 321 from the fixing device 318 to the reverse path 325. Immediately after a rear end of the recording material in the direction of conveyance has passed through a junction point with the double-side path 326, the rotation of the reverse rollers 321 is inverted to cause front-back-side inversion of the recording material and allow the recording material to be conveyed to the double-side path 326. The recording material conveyed to the double-side path 326 is conveyed by the conveying rollers 322 and 323 to the conveying path 316. The recording material conveyed to the conveying path 316 is conveyed again to the registration rollers 308 through the conveying rollers 306, and an image is formed on a second surface of the recording material by the same process as described above. The recording material on which the double-side image formation has been finished is delivered by the delivery rollers 319 and the delivery rollers 324 to the outside of the image forming apparatus 301 in the same manner as during the single-sided printing mode.

When the recording material is delivered to the outside of the image forming apparatus 301 while facing downward, the recording material is temporarily conveyed from the fixing device 318 to the conveying rollers 320. Rotation of the conveying rollers 320 is inverted immediately before the rear end of the recording material in the direction of conveyance passes through the conveying rollers 320 to cause the front-back-side inversion of the recording material. Then, the recording material is delivered by the delivery rollers 324 to the outside of the image forming apparatus 301.

The image forming system 100 has the configuration and the function each described above. A load in the present disclosure is an object to be driven by the motor. For example, each of various rollers such as the feed rollers 303 and 305, the conveying rollers 306 and 307, the registration rollers 308, and the delivery rollers 319, the photosensitive drum 309, the conveying belt 317, the lighting device 20, and the optical system corresponds to the load. The motor control device in this embodiment is applicable to a motor configured to drive such a load.

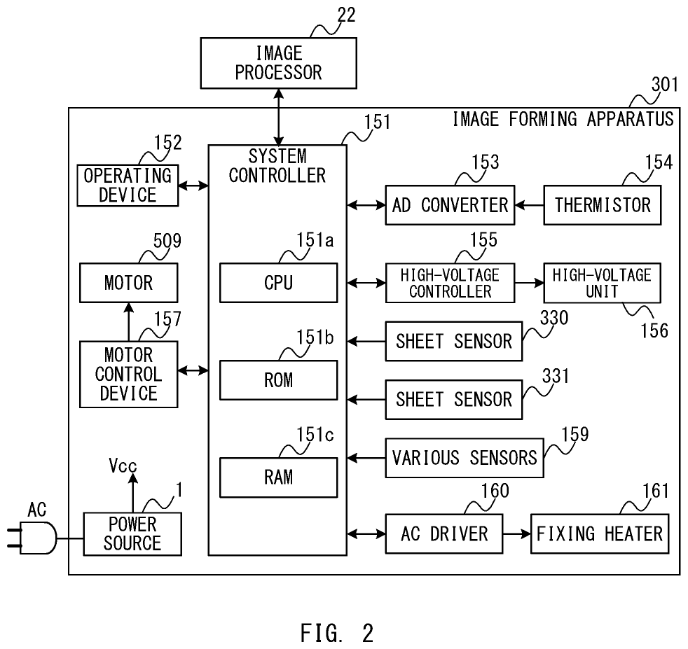

FIG. 2 is an explanatory diagram of a controller configured to control the operation of the image forming system 100. The image forming system 100 includes a power source 1. The power source 1 is connected to an alternating current power source AC. The power source 1 converts the power supplied from the alternating current power source AC to power to be used by each of the components of the image forming system 100, and supplies the converted power to each of the components of the image forming system 100. For example, the power source 1 supplies a voltage Vcc to full-bridge circuits provided in a motor control device 157 and described later. Each of the components of the image forming system 100 is operated with the power supplied from the power source 1.

The overall operation of the image forming system 100 is controlled by a system controller 151 embedded in the image forming apparatus 301. The system controller 151 includes a central processing unit (CPU) 151a, a read only memory (ROM) 151b, and a random access memory (RAM) 151c. The system controller 151 is connected to each of the image processor 22, an operating device 152, an analog-digital (AD) converter 153, a high-voltage controller 155, the motor control device 157, the sheet sensors 330 and 331, various sensors 159, and an AC driver 160. The system controller 151 is capable of transmitting/receiving data, a command, and the like to/from each of the components of the image forming system 100 that are connected thereto.

The CPU 151a executes the computer program stored in the ROM 151b through use of the RAM 151c as a work area to execute various sequences associated with a predetermined image formation sequence. The RAM 151c stores various data such as setting values for the high-voltage controller 155, command values to the motor control device 157, and information obtained from the operating device 152.

The image processor 22 transmits the image data to the system controller 151. The system controller 151 obtains signals from the individual components of the image forming system 100 (signals from the various sensors 159 and the like) and sets the setting values for the high-voltage controller 155 based on the obtained signals. The high-voltage controller 155 controls a high-voltage unit 156 configured to generate a high voltage to be used in the charging device 310, the developing device 314, or the like in accordance with the setting values set by the system controller 151. Thus, the high-voltage unit 156 can supply the required high voltage to the charging device 310, the developing device 314, the transfer charging device 315, or the like.

The system controller 151 controls the motor control device 157 based on the results of the detection by the sheet sensors 330 and 331. The motor control device 157 controls driving by a motor 509 configured to drive a load in response to an instruction obtained from the CPU 151a. Although only the motor 509 is illustrated in FIG. 2, a plurality of motors are actually provided in the image forming system 100. The image forming system 100 may also be configured such that the single motor control device 157 controls a plurality of motors. Alternatively, a plurality of motor control devices 157 may be provided.

The AD converter 153 obtains a result of detection from a thermistor 154 for detecting a temperature of a fixing heater 161 provided in the fixing device 318, converts the detection result to a digital value, and inputs the digital value to the system controller 151. The system controller 151 controls the AC driver 160 based on the digital value obtained from the AD converter 153. Under the control of the system controller 151, the AC driver 160 controls the temperature of the fixing heater 161 to a level appropriate for a fixing process.

The operating device 152 is a user interface including an input key, for example, a numeric keypad, a touch panel, a display, and other components. The system controller 151 displays, on the display of the operating device 152, various setting screens or the like for setting, for example, the type of a recording material to be used. The system controller 151 displays, on the display, information on the number of sheets having images formed thereon and information on whether or not image formation is currently being performed, and the state of the image forming apparatus 301 such as occurrence of jamming or a portion with the jamming.

A user can give an instruction to the image forming system 100 and input a setting value thereto through use of the input key or the touch panel. For example, when the user gives an instruction to initiate image formation through use of the operating device 152, details of the instruction are input from the operating device 152 to the system controller 151. In response to the instruction, the system controller 151 controls various operations for image formation. When the user sets a copy magnification, a density setting value, and the like through use of the operating device 152, the system controller 151 obtains such setting values and performs image formation under conditions determined based on the setting values.

### Vector Control

A description is given of the details of the motor control device 157. The motor control device 157 in this embodiment controls the driving of the motor 509 through vector control. In the following description, the motor 509 is described as a stepping motor, but the motor 509 may also be another motor, for example, a DC motor. In a case described below, the motor 509 is a two-phase motor, but the motor 509 may also be a motor including two or more phases, for example, a three-phase motor. In the motor 509 in this embodiment, a sensor for detecting a rotation phase of a rotor, for example, a rotary encoder is not provided, but a rotary encoder or other such sensors may also be provided therein.

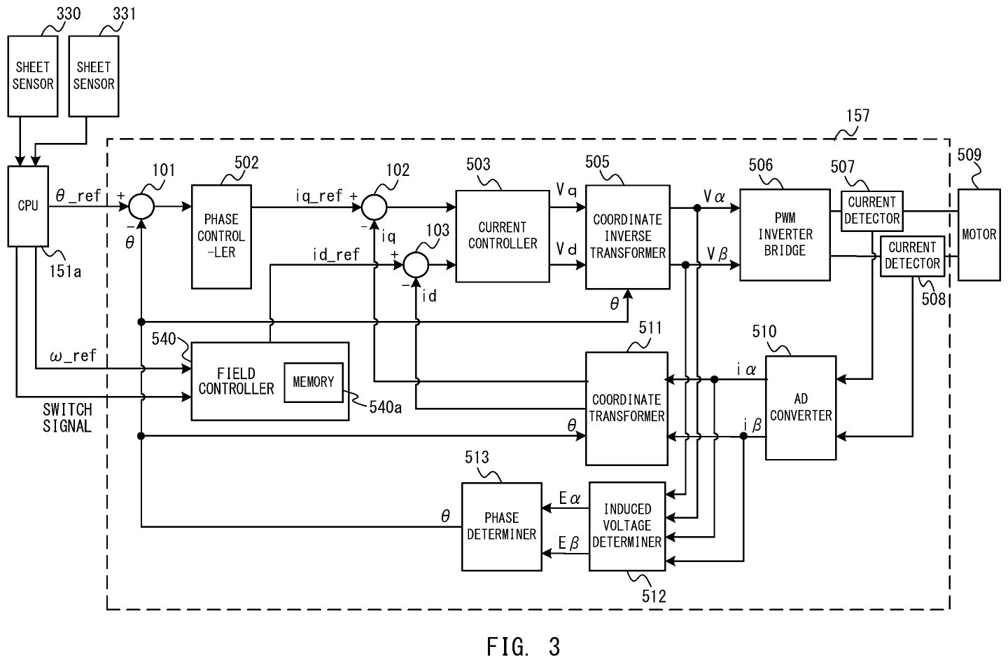

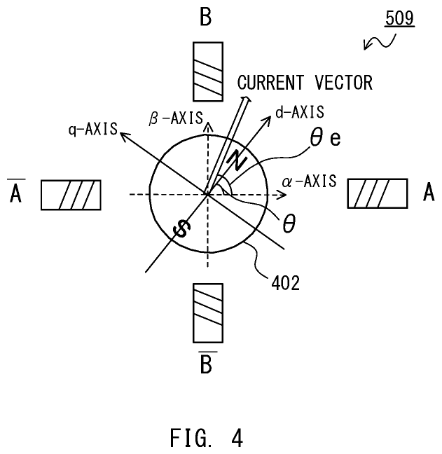

With reference to FIG. 3 and FIG. 4, a description is given of the vector control to be performed by the motor control device 157 in this embodiment. FIG. 3 is an exemplary configuration diagram of the motor control device 157 configured to control the motor 509, which is the stepping motor. FIG. 4 is an explanatory diagram of the motor 509, which is the stepping motor. In FIG. 4, there is illustrated a relationship between the motor 509 including two phases, which are an A-phase (first phase) and a B-phase (second phase), and a rotating coordinate system represented by a d-axis and a q-axis.

In FIG. 4, an α-axis corresponding to an A-phase winding wire and a β-axis corresponding to a B-phase winding wire are defined in a coordinate system at rest. In addition, the d-axis is defined as a direction of a magnetic flux (magnetic flux direction) produced by the magnetic poles of a permanent magnet used in a rotor 402. Meanwhile, the q-axis is defined as a direction located 90 degrees counterclockwise from the d-axis (direction orthogonal to the d-axis). An angle θ formed between the α-axis and the d-axis is defined. The rotation phase of the rotor 402 is represented by the angle θ. In the vector control, there is used a rotating coordinate system based on a rotation phase θ (angle θ) of the rotor 402 of the motor 509.

The vector control is a method involving controlling current values in the rotating coordinate system based on the rotation phase θ of the rotor 402 of the motor 509 to control the rotation of the motor 509. For example, in the vector control, the motor 509 is controlled by phase feedback control, which is performed to control the current values so as to reduce a deviation between a command phase indicative of a target phase of the rotor 402 and an actual rotation phase. Alternatively, the motor 509 may also be controlled by speed feedback control, which is performed to control the current values so as to reduce a deviation between a command speed indicative of a target speed of the rotor 402 and an actual rotating speed. The current values in the rotating coordinate system correspond to a current value of a q-axis component (torque current component), which generates a torque in the rotor 402 of the motor 509, and an current value of a d-axis component (excitation current component), which affects strength of a magnetic flux passing through each of the winding wires of the motor 509.

As illustrated in FIG. 3, the motor control device 157 includes, as a circuit configured to perform the vector control, a phase controller 502, a current controller 503, a coordinate inverse transformer 505, a coordinate transformer 511, a PWM inverter bridge 506 configured to supply a drive current to each of the winding wires of the motor 509, and the like. The coordinate transformer 511 converts the coordinates of a current vector corresponding to each of drive currents flowing through the A- and B-phase winding wires of the motor 509 in the coordinate system at rest represented by the α-axis and the β-axis to those in the rotating coordinate system represented by the q-axis and the d-axis. As a result, each of the drive currents supplied to the A- and B-phase winding wires of the motor 509 is represented by the current value (q-axis current) of the q-axis component and the current value (d-axis current) of the d-axis component, which are the current values in the rotating coordinate system. The q-axis current corresponds to the torque current, which generates a torque in the rotor 402 of the motor 509. The d-axis current corresponds to the excitation current, which affects the strength of the magnetic flux passing through each of the winding wires of the rotor 402 of the motor 509. The motor control device 157 can control the q-axis current and the d-axis current independently of each other. As a result, the motor control device 157 can efficiently generate the torque required by the rotor 402 to rotate.

The motor control device 157 determines the rotation phase θ of the rotor 402 of the motor 509 by a method to be described later and performs the vector control based on a result of the determination. The CPU 151a generates a command phase θ_ref indicative of the target phase of the rotor 402 of the motor 509 and outputs the generated command phase θ_ref at predetermined time periods to the motor control device 157. A subtractor 101 calculates a deviation between the rotation phase θ of the rotor 402 of the motor 509 and the command phase θ_ref and transmits the calculated deviation to the phase controller 502.

The phase controller 502 generates a q-axis current command value iq_ref based on proportional control (P), integral control (I), and differential control (D) so as to reduce the deviation obtained from the subtractor 101, and outputs the q-axis current command value iq_ref. Specifically, the phase controller 502 generates the q-axis current command value iq_ref (target value) based on the P control, the I control, and the D control so as to reduce the deviation obtained from the subtractor 101 to “0”, and outputs the q-axis current command value iq_ref. The P control is a control method of controlling a target value to be controlled based on a value proportional to a deviation between a command value and an estimated value. The I control is a control method of controlling a target value to be controlled based on a value proportional to a time integral of the deviation between a command value and an estimated value. The D control is a control method of controlling a target value to be controlled based on a value proportional to a time variation of the deviation between a command value and an estimated value. The phase controller 502 in this embodiment generates the q-axis current command value iq_ref based on the PID control, but the generation of the q-axis current command value iq_ref is not limited thereto. For example, the phase controller 502 may also generate the q-axis current command value iq_ref based on the PI control.

The respective drive currents flowing through the A- and B-phase winding wires of the motor 509 are detected by current detectors 507 and 508 and converted by an AD converter 510 from analog values to digital values. The current values of the drive currents converted by the AD converter 510 from the analog values to the digital values are given as current values iα and iβ in the coordinate system at rest by the following expressions through use of a phase θe of the current vector illustrated in FIG. 4. The phase θe of the current vector is defined as the angle formed between the α-axis and the current vector, while “I” represents a magnitude of the current vector.

iα=I*cos θe (1)

iβ=I*sin θe (2)

The current values iα and iβ are input to the coordinate transformer 511 and an induced voltage determiner 512. The coordinate transformer 511 converts the current values iα and iβ in the coordinate system at rest to a current value iq of the q-axis current and a current value id of the d-axis current in the rotating coordinate system in accordance with the following expressions.

id=cos θ*iα+sin θ*iβ (3)

iq=−sin θ*iα+cos θ*iβ (4)

As described above, the coordinate transformer 511 converts the coordinates of a current vector corresponding to each of the drive currents flowing through the A- and B-phase winding wires of the motor 509 in the coordinate system at rest represented by the α-axis and the β-axis to those in the rotating coordinate system represented by the q-axis and the d-axis. A subtractor 102 obtains the q-axis current command value iq_ref output from the phase controller 502 and the current value iq output from the coordinate transformer 511. The subtractor 102 calculates a deviation between the q-axis current command value iq_ref and the current value iq and transmits the calculated deviation to the current controller 503. A subtractor 103 obtains a d-axis current command value id_ref output from a field controller 540 and the current value id output from the coordinate transformer 511. The subtractor 103 calculates a deviation between the d-axis current command value id_ref and the current value id and transmits the calculated deviation to the current controller 503. The field controller 540 transmits the d-axis current command value id_ref in accordance with an instruction ω_ref from the CPU 151a to the subtractor 103. The field controller 540 includes a memory 540a configured to store a table for showing, for example, the relationship between the instruction ω_ref and the d-axis current command value id_ref. The field controller 540 refers to the table to obtain the d-axis current command value id_ref based on the instruction ω_ref. The field controller 540 is a controller for controlling the current value id of the d-axis current.

The current controller 503 generates drive voltages Vq and Vd based on PID control so as to reduce each of the deviations. Specifically, the current controller 503 generates the drive voltages Vq and Vd so as to reduce each of the deviations to “0” and outputs the drive voltages Vq and Vd to the coordinate inverse transformer 505. In other words, the current controller 503 has a voltage generating function. Note that, the current controller 503 in this embodiment generates the drive voltages Vq and Vd based on the PID control, but the generation of the drive voltages Vq and Vd is not limited thereto. For example, the current controller 503 may also generate the drive voltages Vq and Vd based on the PI control.

The coordinate inverse transformer 505 inverse-transforms the drive voltages Vq and Vd in the rotating coordinate system, which is output from the current controller 503, to drive voltages Vα and Vβ in the coordinate system at rest in accordance with the following expressions.

Vα=cos θ*Vd−sin θ*Vq (5)

Vβ=sin θ*Vd+cos θ*Vq (6)

The coordinate inverse transformer 505 outputs the drive voltages Vq and Vd resulting from the inverse transformation to the induced voltage determiner 512 and the PWM inverter bridge 506. The PWM inverter bridge 506 has full-bridge circuits. The full-bridge circuits are driven by PWM signals based on the drive voltages Vα and Vβ input from the coordinate inverse transformer 505. As a result, the PWM inverter bridge 506 generates the drive currents iα and iβ based on the drive voltages Vα and Vβ and supplies the generated drive currents iα and iβ to the respective winding wires of the motor 509 for the individual phases, to thereby drive the motor 509. In other words, the PWM inverter bridge 506 has the function of supplying the currents to the motor 509. The respective full-bridge circuits are provided correspondingly to the A- and B-phases of the motor 509. The PWM inverter bridge 506 may also be formed of half-bridge circuits or the like.

A description is given of a method of determining the rotation phase θ. For determination of the rotation phase θ of the rotor 402, induced voltages Eα and Eβ induced in the A- and B-phase winding wires of the motor 509 by the rotation of the rotor 402 are used. The induced voltages Eα and Eβ are determined (calculated) by the induced voltage determiner 512. Specifically, the induced voltage determiner 512 obtains the current values iα and iβ of the drive currents iα and iβ, which are digital values resulting from conversion by the AD converter 510, and the drive voltages Vα and Vβ output from the coordinate inverse transformer 505. The induced voltage determiner 512 calculates the values of the induced voltages Eα and Eβ based on the obtained current values and voltage values and the following voltage equations.

Eα=Vα−R*iα−L*diα/dt (7)

Eβ=Vβ−R*iβ−L*diβ/dt (8)

where R represents a winding wire resistance, and L represents a winding wire inductance.

The values of R and L are specific to the motor 509 and stored in advance in the ROM 151b or in a memory (not shown) provided in the motor control device 157.

The calculated (determined) induced voltages Eα and Eβ are input to a phase determiner 513. The phase determiner 513 calculates (determines) the rotation phase of the rotor 402 of the motor 509 in accordance with the following expression based on a ratio between the induced voltage Ea and the induced voltage Eβ. The calculated rotation phase θ of the rotor 402 is input to the subtractor 101, the coordinate inverse transformer 505, and the coordinate transformer 511 as described above.

A=tan \hat{ }−1(−Eβ/Eα) (9)

Note that, in this embodiment, the phase determiner 513 determines the rotation phase θ by performing an arithmetic operation based on the expression (9), but the determination of the rotation phase θ is not limited thereto. For example, the phase determiner 513 may also store a table for showing the relationships between the induced voltages Eα and Eβ and the rotation phase θ corresponding to the induced voltages Eα and Eβ in the ROM 151b or the like, and refer to the table to determine the rotation phase θ.

The motor control device 157 repeatedly performs the above-mentioned control.

### Field Strengthening

Next, a description is given of field strengthening. The field strengthening is a technique for controlling the excitation current component such that a magnetic flux stronger than the magnetic flux of the rotor 402 passes through each of the winding wires, to thereby enhance a holding force for holding the rotor 402. Specifically, the excitation current component is controlled to have a positive value to apparently increase the strength of the magnetic flux of the rotor 402 and allow a magnetic flux stronger than the magnetic flux of the rotor 402 to pass through each of the winding wires. Consequently, the holding force for holding the rotor 402 is enhanced. When the excitation current component has a positive value, and as an absolute value thereof becomes larger, the holding force becomes larger.

### Application Example 1 of Field Strengthening

A description is given of a case in which the field strengthening is applied to original conveyance in the original reading apparatus 201. The original reading apparatus 201 drives the feed roller 3 and the conveying rollers 4, 6, 7, and 8 to convey the original P at a fixed speed to a reading position 15. At this time, occurrence of fluctuations in rotating speed of any of the rollers may vary the speed of conveying the original P. Consequently, the read original image suffers from formation of a streaked image or deterioration of a partial magnification, resulting in a defective image.

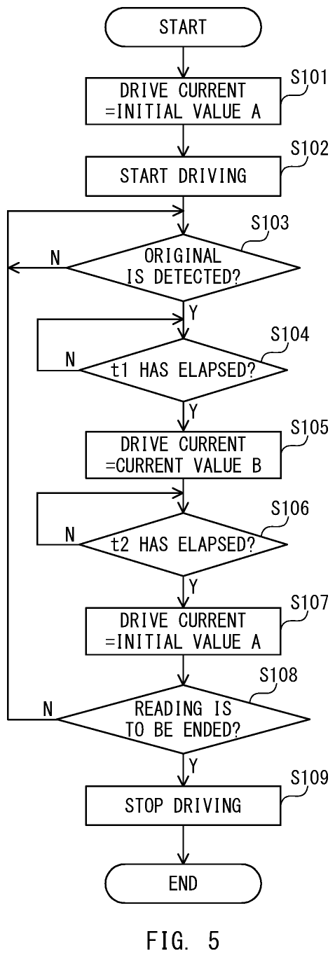

FIG. 5 is a flow chart for illustrating processing of controlling the driving by the motor 509 during reading of the original image. The processing is performed in cooperation by the CPU 151a and the motor control device 157. The motor 509 described herein is a stepping motor configured to drive the conveying rollers 8.

When obtaining an instruction to read an image from the operating device 152, the CPU 151a sets the d-axis current command value id_ref output from the field controller 540 to an initial value A (Step S101). The CPU 151a causes the motor control device 157 to start to drive the various rollers (Step S102). Thus, the conveyance of the original P is initiated. The initial value A is a design value set in accordance with the rotating speed of the motor 509 or load specifications, and may be any one of a positive value, zero, and a negative value. In general, the initial value A is set to such a value as to enhance power consumption efficiency, for example, 0 A. In the following, control of the motor to be performed when the initial value A is set to 0 A is described.

The CPU 151a waits after the initiation of the conveyance of the original P until the sheet sensor SS1 detects the original P (Step S103). When the sheet sensor SS1 detects the original P (“Y” in Step S103), the CPU 151a waits until a predetermined time period t1 elapses (“N” in Step S104). The predetermined time period t1 is set shorter than the time period required after a leading end of the original P in the direction of conveyance is detected by the sheet sensor SS1 until the leading end of the original P reaches a nip portion of the conveying rollers 8.

When the predetermined time period t1 has elapsed (“Y” in Step S104), the CPU 151a outputs a switch signal to the field controller 540 so as to switch, to a current value B, the d-axis current command value id_ref output from the field controller 540 (Step S105). In response to the switch signal, the field controller 540 switches the d-axis current command value id_ref to be output therefrom from the initial value A (=0 A) to the current value B (for example, 0.3 A). As a result, the field strengthening is initiated. The current value B is a positive value larger than the initial value A. The d-axis current is a component for generating the holding force and affects an effect of inhibiting disturbance in the rotating direction. Through enhancement of the holding force of the motor 509 at the time when the leading end of the original P enters the nip portion of the conveying rollers 8, it is possible to inhibit an image quality from being degraded by fluctuations in speed of the conveying rollers 8.

The CPU 151a waits until a predetermined time period t2 elapses from the switching of the drive current Id (“N” in Step S106). When the predetermined time period t2 has elapsed (“Y” in Step S106), the CPU 151a outputs a switch signal to the field controller 540 so as to switch, to the initial value A, the d-axis current command value id_ref to be output from the field controller 540 (Step S107). In response to the switch signal, the field controller 540 switches the d-axis current command value id_ref to be output therefrom from the current value B to the initial value A. As a result, the field strengthening is ended. The predetermined time period t2 is a predetermined time period until a sufficient time period (for example, about 100 milliseconds) elapses after the passage of the leading end of the original P through the conveying rollers 8. After the lapse of the predetermined time period t2, disturbance entailing large speed fluctuations does not occur. Thus, during the period during which disturbance entailing large speed fluctuations does not occur, the d-axis current command value id_ref is set to 0 A. As a result, it is possible to inhibit increased power consumption resulting from setting of the excitation current component to a value other than zero.

After the d-axis current command value id_ref is switched to the initial value A, the CPU 151a determines whether an image reading job is to be ended (Step S108). When the image reading job is not to be ended (“N” in Step S108), the CPU 151a repeatedly performs the processing including and subsequent to Step S103 until the image reading job is ended. When the image reading job is to be ended (“Y” in Step S108), the CPU 151a causes the motor control device 157 to stop the driving of the various rollers (Step S109). Thus, the processing of reading the original image is ended.

As described above, only during the period during which the holding force of the motor 509 is required to be enhanced (the field strengthening is required to be performed), the field strengthening is performed. Specifically, at the time when the leading end of the original P enters the nip portion of the conveying rollers 8 (timing of the occurrence of disturbance due to the load), the field strengthening is performed. Through the field strengthening, it is possible to reduce fluctuations in speed of the motor 509 due to disturbance. Consequently, it is possible to inhibit the degradation of the image quality of the read original image. In addition, the field strengthening is performed only during the period during which the field strengthening is required to be performed, and hence it is possible to reduce the period during which the d-axis current command value id_ref is set to the current value B (the field strengthening is performed) while the motor 509 is driven. Accordingly, it is possible to prevent increased power consumption. In the description given above, an impact generated when the original has entered the nip portion of the conveying rollers 8 is used as an example of a factor causing disturbance. However, the disturbance causing factor is not limited thereto. In addition, through free setting of the predetermined time periods t1 and t2, it is possible to switch the drive current depending on a known disturbance causing factor.

### Application Example 2 of Field Strengthening

A description is given of a case in which the field strengthening is applied to the conveyance of a recording material in the image forming apparatus 301. In the motor 509 of the image forming apparatus 301 also, through increase of the d-axis current command value id_ref depending on disturbance, it is possible to inhibit the degradation of an image quality during image formation. A description is given herein of a case in which the recording material is conveyed by the conveying rollers 306 and 307.

A fed recording material is conveyed by the conveying rollers 306 and 307 to the registration rollers 308. The registration rollers 308 convey the recording material to the transfer position at the time when the toner image formed on the photosensitive drum 309 is conveyed to the transfer position. The registration rollers 308 perform skew correction of the recording material. In the skew correction, to form a predetermined amount of loop in the recording material, the recording material is pressed against a nip portion of the registration rollers 308, and the conveying rollers 306 convey the recording material.

When the impact generated when the leading end of the recording material collides with the nip portion of the registration rollers 308 causes fluctuations in rotating speed of the conveying rollers 306, the predetermined amount of loop may not be formed in the recording material. In this case, it may be possible that the skew correction does not achieve a satisfactory effect. In this embodiment, at the time when the recording material collides with the nip portion of the registration rollers 308 and disturbance occurs in the conveying rollers 306, the drive current given by the motor 509 to the conveying rollers 306 is switched to a larger value to reduce speed fluctuations.

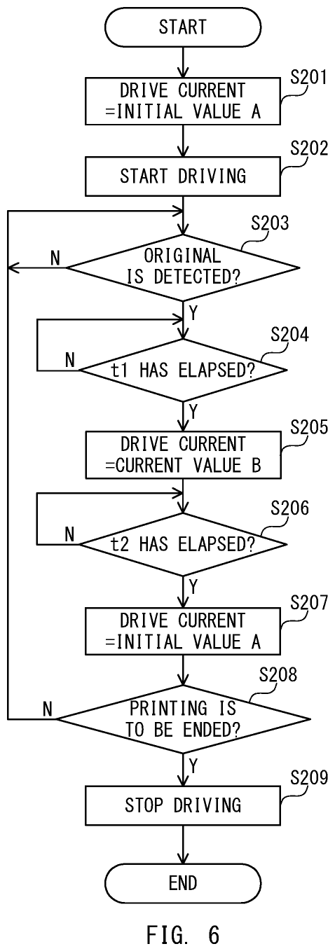

FIG. 6 is a flow chart for illustrating processing of controlling the driving of the motor 509 during the conveying of such a recording material as described above. The processing is performed in cooperation by the CPU 151a and the motor control device 157. The motor 509 described herein is a stepping motor configured to drive the conveying rollers 306.

When obtaining an instruction to form an image from the operating device 152, the CPU 151a sets the d-axis current command value id_ref output from the field controller 540 to the initial value A (Step S201). The CPU 151a causes the motor control device 157 to start to drive each of the rollers on a conveyance path (Step S202). Thus, feeding of the recording material is initiated. The initial value A is a design value set in accordance with the rotating speed of the motor 509 or load specifications, and may be any one of a positive value, zero, and a negative value. In general, the initial value A is set to such a value as to enhance power consumption efficiency, for example, 0 A. In the following, control of the motor to be performed when the initial value A is set to 0 A is described.

The CPU 151a waits after the initiation of the conveyance of the recording material until the sheet sensor 330 detects the recording material (Step S203). When the sheet sensor 330 detects the recording material (“Y” in Step S203), the CPU 151a waits until the predetermined time period t1 elapses (“N” in Step S204). The predetermined time period t1 is set shorter than the time period required after a leading end of the recording material in the direction of conveyance is detected by the sheet sensor 330 until the leading end of the recording material reaches the nip portion of the registration rollers 308.

When the predetermined time period t1 has elapsed (“Y” in Step S204), the CPU 151a outputs a switch signal to the field controller 540 so as to switch, to a current value B, the d-axis current command value id_ref output from the field controller 540 (Step S205). In response to the switch signal, the field controller 540 switches the d-axis current command value id_ref to be output therefrom from the initial value A (=0 A) to the current value B (for example, 0.3 A). As a result, the field strengthening is initiated. The current value B is a positive value larger than the initial value A. The d-axis current is a component for generating the holding force and affects the effect of inhibiting disturbance in the rotating direction. Through the enhancement of the holding force of the motor 509 at the time when the leading end of the recording material collides with the nip portion of the registration rollers 308, fluctuations in speed of the conveying rollers 306 are inhibited. This improves the following performance of the position of the recording material being conveyed when the recording material collides with the nip portion of the registration rollers 308.

The CPU 151a waits until the predetermined time period t2 elapses from the switching of the drive current Id (“N” in Step S206). When the predetermined time period t2 has elapsed (“Y” in Step S206), the CPU 151a outputs a switch signal to the field controller 540 so as to switch, to the initial value A, the d-axis current command value id_ref to be output from the field controller 540 (Step S207). In response to the switch signal, the field controller 540 switches the d-axis current command value id_ref to be output therefrom from the current value B to the initial value A. As a result, the field strengthening is ended. The predetermined time period t2 is a predetermined time period until a sufficient time period elapses after the leading end of the recording material collides with the nip portion of the registration rollers 308 and forms the predetermined amount of loop. After the lapse of the predetermined time period t2, disturbance entailing large speed fluctuations does not occur. Thus, during the period during which disturbance entailing large speed fluctuations does not occur, the d-axis current command value id_ref is set to 0 A. As a result, it is possible to prevent increased power consumption resulting from the setting of the excitation current component to a value other than zero.

After the d-axis current command value id_ref is switched to the initial value A, the CPU 151a determines whether a printing job is to be ended (Step S208). When the printing job is not to be ended (“N” in Step S208), the CPU 151a repeatedly performs the processing including and subsequent to S203 until the printing job is ended. When the printing job is to be ended (“Y” in Step S208), the CPU 151a causes the motor control device 157 to stop the driving of each of the rollers on a conveyance path (Step S209). Thus, the processing of conveying the recording material during image formation is ended.

The CPU 151a sets the current value of the drive current from the motor 509 larger than the initial value at the time when disturbance occurs, to thereby be able to reduce fluctuations in speed of the motor 509 due to the disturbance. As a result, conveyance accuracy exhibited when the recording material collides with the nip portion of the registration rollers 308 is improved to be able to prevent a reduction in the effect of skew correction. In the description given above, an impact generated when the recording material has entered the nip portion of the registration rollers 308 is used as an example of a factor causing disturbance. However, the disturbance causing factor is not limited thereto. In addition, through free setting of the predetermined time periods t1 and t2, it is possible to switch the drive current depending on a known disturbance causing factor.

As described above, only during the period during which the holding force of the motor 509 is required to be enhanced (the field strengthening is required to be performed), the field strengthening is performed. Specifically, at the time when the leading end of the recording material enters the nip portion of the registration rollers 308 (time of the occurrence of disturbance), the current value of the excitation current component is adjusted (the field strengthening is performed). More specifically, at the time when the leading end of the recording material reaches a predetermined position upstream of the nip portion of the registration rollers 308 in the direction of conveyance of the recording material, the field strengthening is initiated. Then, at the time when the leading end of the recording material reaches a second predetermined position downstream of the nip portion of the registration rollers 308 in the direction of conveyance, the field strengthening is ended. Through the performing of the field strengthening, fluctuations in rotating speed of the motor 509 due to disturbance are inhibited. Accordingly, the load is stably driven. When the load is the conveying roller configured to convey the recording material, it is possible to stably convey the recording material and prevent the degradation of an image during image formation. When the load is the conveying roller configured to convey an original, it is possible to stably convey the original to prevent the degradation of a read image.

In addition, the field strengthening is performed only during the period during which the field strengthening is required to be performed, and hence it is possible to reduce the period during which the d-axis current command value id_ref is set to the current value B (the field strengthening is performed) while the motor 509 is driven. Accordingly, it is possible to prevent increased power consumption. Note that, in the description given above, an impact generated when the recording material has entered the nip portion of the registration rollers 308 is used as an example of a factor causing disturbance. However, the disturbance causing factor is not limited thereto.

Note that, in this embodiment, the values stored as the d-axis current command value id_ref in the memory 540a are 0 A and 0.3 A, but are not limited thereto. Three or more values may also be stored as the d-axis current command value id_ref. In this case, for example, the CPU 151a outputs to the field controller 540 a signal indicative of which one of the values is to be used, and the field controller 540 switches the d-axis current command value id_ref to be output therefrom based on this signal.

Note that, in this embodiment, the field strengthening is controlled based on the results of detection by the sheet sensors, but the control of the field strengthening is not limited thereto. For example, when the predetermined time period T1 elapses from the initiation of the driving of the conveying rollers 306 to a predetermined time period before the leading end of the recording material enters the nip portion of the registration rollers 308, the field strengthening is initiated. Alternatively, when the predetermined time period t1 elapses from when the leading end of the original P is detected by the sheet sensor SS1 to when the leading end of the original P reaches the nip portion of the conveyance rollers 8, the field strengthening is initiated. Still alternatively, when the predetermined time period T2 elapses from the initiation of the driving of the conveying rollers 8 (conveying rollers 306) to a predetermined time period when disturbance entailing large speed fluctuations no longer occurs, the field strengthening is ended. The image forming apparatus may also be configured as described above. The predetermined time periods are determined based on, for example, the pre-set operation sequence of the image forming apparatus. Alternatively, the predetermined time periods may also be determined based on the number of pulses output to the motor 509.

In this embodiment, during the period during which the leading end of the sheet (the original or the recording material) is upstream of the sheet sensors, the d-axis current command value is set to 0 A, but the d-axis current command value may also be set to a value other than 0 A. Specifically, it is only required that the d-axis current command value during the period during which the leading end of the sheet is upstream of the sheet sensors be a value smaller than the current value B. In other words, it is only required that a magnetic flux passing through each of the winding wires during the period during which the leading end of the sheet is upstream of the sheet sensors be weaker than the magnetic flux passing through each of the winding wires during the period until the predetermined time period t2 elapses from the sensing of the leading end of the sheet by the sheet sensors. However, as the set d-axis current command value becomes closer to 0 A, it is possible to more effectively prevent increased power consumption.

In this embodiment, the field controller 540 switches the d-axis current command value id_ref directly from 0 A to 0.3 A (or from 0.3 A to 0 A). However, the d-axis current command value id_ref may also be switched by, for example, being gradually varied. Moreover, in this embodiment, the d-axis current command value id_ref obtained when the field strengthening is performed is set to 0.3 A irrespective of the type of the sheet to be conveyed. However, the setting of the d-axis current command value id_ref is not limited thereto. For example, the d-axis current command value id_ref obtained when the field strengthening is performed may also be set in accordance with the type of the sheet to be conveyed.

In this embodiment, as the rotor 402, the permanent magnet is used, but the rotor 402 is not limited thereto.

Moreover, in the vector control in this embodiment, the phase feedback control is performed to control the motor, but the control of the motor is not limited thereto. For example, the image forming apparatus may also be configured to feed back the rotating speed ω of the rotor 402 and thus control the motor. Specifically, the image forming apparatus may also be configured to control the motor based on a deviation between a rotating speed ω determined based on a time variation of the rotation phase θ output from the phase determiner 513 and a command speed ω_ref output from the CPU 151a.

While this invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-113360, filed Jun. 14, 2018 which is hereby incorporated by reference herein in its entirety.

What is claimed is:

1. A sheet conveying apparatus, comprising:
a conveying roller configured to convey a sheet;
a motor configured to drive the conveying roller;
a phase determiner configured to determine a rotation phase of a rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced, and to control the drive current flowing through the winding such that a deviation between a value of an excitation current component of the drive current detected by the detector and a target value of the excitation current component, wherein the torque current component is a current component that generates a torque in the rotor and is represented in a rotating coordinate system based on the rotation phase determined by the phase determiner and wherein the excitation current component is a current component that affects a strength of a magnetic flux passing through the winding and is represented in the rotating coordinate system;
wherein the controller is configured to set the target value of the torque current component so as to reduce a deviation between an instructed phase indicative of a target phase of the rotor and the rotation phase determined by the phase determiner,
wherein the controller is configured to set the target value of the excitation current component such that, during a first period, the magnetic flux passing through the winding wire is stronger than a magnetic flux of the rotor, the first period is a period after a leading end of the sheet reaches a predetermined position upstream of the conveying roller in a direction of conveyance of the sheet, and
wherein the controller is configured to set the target value of the excitation current component such that, during a second period, the magnetic flux passing through the winding wire is weaker than the magnetic flux passing through the winding wire during the first period, the second period is a period before the leading end of the sheet reaches the predetermined position.

2. A sheet conveying apparatus, comprising:
a conveying roller configured to convey a sheet;
a motor configured to drive the conveying roller;
a phase determiner configured to determine a rotation phase of a rotor of the motor;
a speed determiner configured to determine a rotation speed of the rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced; and to control the drive current flowing through the winding such that a deviation between a value of an excitation current component of the drive current detected by the detector and a target value of the excitation current component, wherein the torque current component is a current component that generates a torque in the rotor and is represented in a rotating coordinate system based on the rotation phase determined by the phase determiner and wherein the excitation current component is a current component that affects a strength of a magnetic flux passing through the winding and is represented in the rotating coordinate system;
wherein the controller is configured to set the target value of the torque current component so as to reduce a deviation between an instructed speed indicative of a target speed of the rotor and the rotation speed determined by the speed determiner,
wherein the controller is configured to set the target value of the excitation current component such that, during a first period, the magnetic flux passing through the winding wire is stronger than a magnetic flux of the rotor, the first period is a period after a leading end of the sheet reaches a predetermined position upstream of the conveying roller in a direction of conveyance of the sheet; and
wherein the controller is configured to set the target value of the excitation current component such that, during a second period, the magnetic flux passing through the winding wire is weaker than the magnetic flux passing through the winding wire during the first period, the second period is a period before the leading end of the sheet reaches the predetermined position.

3. A sheet conveying apparatus, comprising:
a first conveying roller configured to convey a sheet;
a motor configured to drive the conveying roller;
a phase determiner configured to determine a rotation phase of a rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced, and to perform field strengthening for increasing a strength of a magnetic flux passing through the winding by controlling a value of an excitation current component of the drive current flowing through the winding of the motor, wherein the torque current component is a current component that generates a torque in the rotor and is represented in a rotating coordinate system based on the rotation phase determined by the phase determiner and wherein the excitation current component is a current component that affects the strength of the magnetic flux passing through the winding and is represented in the rotating coordinate system,
wherein the controller is configured to set the target value of the torque current component so as to reduce a deviation between an instructed phase indicative of a target phase of the rotor and the rotation phase determined by the phase determiner, and
wherein the controller is configured to change a degree of the field strengthening from a first degree to a second degree at a first timing, the second degree being greater than the first degree and the first timing being a timing when a leading edge of the sheet positions at a position upstream of the first conveying roller in a conveying direction in which the sheet is conveyed.

4. The sheet conveying apparatus according to claim 3, wherein the sheet is a sheet that is to be firstly conveyed by the first conveying roller after the driving of the motor is started.

5. The sheet conveying apparatus according to claim 3, further comprising:
a second conveying roller,
wherein the leading edge of the sheet at the first timing positions at a predetermined position upstream of the first conveying roller in the conveying direction, and
the predetermined position is a position between the first conveying roller and the second conveying roller disposed adjacently to the first conveying roller and upstream of the first conveying roller in the conveying direction.

6. The sheet conveying apparatus according to claim 5, wherein a first sheet sensor configured to detect the leading edge of the sheet is provided at the predetermined position, and the controller changes the degree of the field strengthening according to the detection of the leading edge of the sheet by the first sheet sensor.

7. The sheet conveying apparatus according to claim 3, wherein a condition when the degree of the field strengthening is in the first degree includes a condition not performing the field strengthening.

8. The sheet conveying apparatus according to claim 3, wherein
the controller continues a condition that the degree of the field strengthening is in the second degree during a period from the first timing to a second timing, and
the second timing is a timing when a leading edge of the sheet positions at a position downstream of the first conveying roller in the conveying direction.

9. A sheet conveying apparatus, comprising:
a first conveying roller configured to convey a sheet;
a motor configured to drive the conveying roller;
a phase determiner configured to determine a rotation phase of a rotor of the motor;
a speed determiner configured to determine a rotation speed of the rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced, and to perform field strengthening for increasing a strength of a magnetic flux passing through the winding by controlling a value of an excitation current component of the drive current flowing through the winding of the motor, wherein the torque current component is a current component that generates a torque in the rotor and is represented in a rotating coordinate system, based on the rotation phase determined by the phase determiner and wherein the excitation current component is a current component that affects the strength of the magnetic flux passing through the winding and is represented in the rotating coordinate system,
wherein the controller is configured to set the target value of the torque current component so as to reduce a deviation between a instructed speed indicative of a target speed of the rotor and the rotation speed determined by the speed determiner, and
wherein the controller is configured to changes a degree of the field strengthening from a first degree to a second degree at a first timing, the second degree being greater than the first degree and the first timing being a timing when a leading edge of the sheet positions at a position upstream of the first conveying roller in a conveying direction in which the sheet is conveyed.

10. The sheet conveying apparatus according to claim 9, wherein the sheet is a sheet that is to be firstly conveyed by the first conveying roller after the driving of the motor is started.

11. The sheet conveying apparatus according to claim 9, further comprising:
a second conveying roller,
wherein the leading edge of the sheet at the first timing positions at a predetermined position upstream of the first conveying roller in the conveying direction,
the predetermined position is a position between the first conveying roller and the second conveying roller disposed adjacently to the first conveying roller and upstream of the first conveying roller in the conveying direction.

12. The sheet conveying apparatus according to claim 11, wherein a sheet sensor configured to detect the leading edge of the sheet is provided at the predetermined position, and the controller changes the degree of the field strengthening according to the detection of the leading edge of the sheet by the first sheet sensor.

13. The sheet conveying apparatus according to claim 9, wherein a condition when the degree of the field strengthening is in the first degree includes a condition not performing the field strengthening.

14. The sheet conveying apparatus according to claim 9, wherein
the controller continues a condition that the degree of the field strengthening is in the second degree during a period from the first timing to a second timing, and
the second timing is a timing when a leading edge of the sheet positions at a position downstream of the first conveying roller in the conveying direction.

15. The sheet conveying apparatus according to claim 9, wherein the controller changes the degree of the field strengthening by changing a target value of the excitation current component.

16. The sheet conveying apparatus according to claim 15,
wherein, in a case where the target value of the excitation current component is a first value, a strength of a magnetic flux generated due to the excitation current component, is greater than a strength of a magnetic flux in a case where the target value of the excitation current component is a second value that is less than the first value, in a magnetic flux direction of the rotor, and
wherein, in a case where the target value of the excitation current component is the first value, the degree of the field strengthening is less than the degree of the field strengthening in a case where the target value of the excitation current component is the second value.

17. The sheet conveying apparatus according to claim 16, wherein the second value is a positive value.

18. The sheet conveying apparatus according to claim 9, wherein the controller controls the degree of the field strengthening based on a type of the sheet conveyed.

19. An document reading apparatus, comprising:
an document tray on which a document is to be stacked;
a conveying roller configured to convey the document;
a reader configured to read the document conveyed by the conveying roller,
a motor configured to drive the conveying roller;
a phase determiner configured to determine a rotation phase of a rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced, and to perform field strengthening for increasing a strength of a magnetic flux passing through the winding by controlling a value of an excitation current component of the drive current flowing through the winding of the motor, wherein the torque current component is a current component that generates a torque in the rotor and is represented in a rotating coordinate system based on the rotation phase determined by the phase determiner and wherein the excitation current component is a current component that affects the strength of the magnetic flux passing through the winding and is represented in the rotating coordinate system,
wherein the controller is configured to set the target value of the torque current component so as to reduce a deviation between an instructed phase indicative of a target phase of the rotor and the rotation phase determined by the phase determiner, and
wherein the controller is configured to change a degree of the field strengthening from a first degree to a second degree at a first timing, the second degree being greater than the first degree and the first timing being a timing when a leading edge of the sheet positions at a position upstream of the first conveying roller in a conveying direction in which the sheet is conveyed.

20. An image forming apparatus, comprising:
a conveying roller configured to convey a sheet;
an image forming unit configured to form an image on the sheet conveyed by the conveying roller,
a motor configured to drive the conveying roller;
a phase determiner configured to determine a rotation phase of a rotor of the motor;
a detector configured to detect a drive current flowing through a winding of the motor; and
a controller configured to control the drive current flowing through the winding of the motor such that a deviation between a value of a torque current component of the drive current detected by the detector and a target value of the torque current component is reduced, and to perform field strengthening for increasing a strength of a magnetic flux passing through the winding by controlling a value of an excitation current component of the drive current flowing through the winding of the motor, wherein the torque current component is a current component that generates a torque in the rotor and is represented in a rotating coordinate system based on the rotation phase determined by the phase determiner and wherein the excitation current component is a current component that affects the strength of the magnetic flux passing through the winding and is represented in the rotating coordinate system,
wherein the controller is configured to set the target value of the torque current component so as to reduce a deviation between an instructed phase indicative of a target phase of the rotor and the rotation phase determined by the phase determiner, and
wherein the controller is configured to change a degree of the field strengthening from a first degree to a second degree at a first timing, the second degree being greater than the first degree and the first timing being a timing when a leading edge of the sheet positions at a position upstream of the first conveying roller in a conveying direction in which the sheet is conveyed.
